(19) United States
(12) Patent Application Publication
(10) Pub. No.: US 2005/0037293 A1
(43) Pub. Date: Feb. 17, 2005

(54) Ink jet imaging of a lithographic printing plate

(76) Inventor: Albert S. Deutsch, Somers, NY (US)

Correspondence Address: HAYES, SOLOWAY P.C., 130 W. CUSHING STREET, TUCSON, AZ, 85701, US

(21) Appl. No.: 10/804,871

(22) Filed: Mar. 19, 2004

Related U.S. Application Data
(63) Continuation-in-part of application No. 10/774,119, filed on Feb. 6, 2004.
Application No. 10/774,119 is a division of application No. 10/057,152, filed on Oct. 25, 2001, now Pat. No. 6,691,618.
Application No. 10/057,152 is a continuation-in-part of application No. 09/941,304, filed on Aug. 29, 2001, now Pat. No. 6,796,235.
Application No. 10/057,152 is a continuation-in-part of application No. 09/941,323, filed on Aug. 29, 2001, now Pat. No. 6,523,471.
Application No. 09/941,323 is a division of application No. 09/566,455, filed on May 8, 2000, now Pat. No. 6,315,916.
(60) Provisional application No. 60/455,836, filed on Mar. 19, 2003.

(51) Int. Cl. G03C 5/18

(52) U.S. Cl. 430/434

(57) ABSTRACT

A process for imaging a lithographic printing plate by ink jet printing imagewise a near infrared absorbing material onto a coated plate. The plate is then exposed to near infrared emitters followed by developing the coating.

### CROSS REFERENCE TO RELATED APPLICATIONS

This application is a continuation-in-part of U.S. application Ser. No. 10/774,119, filed Feb. 6, 2004, which in turn is a continuation-in-part of U.S. application Ser. No. 09/941,304, filed Aug. 29, 2001 and a continuation-in-part of application Ser. No. 09/941,323, also filed on Aug. 29, 2001, now U.S. Pat. No. 6,523,471, which are, in turn, divisionals of U.S. application Ser. No. 09/566,453, filed May 8, 2000, now U.S. Pat. No. 6,315,916. This application also claims benefit of U.S. Provisional Application Ser. No. 60/455,836 filed on Mar. 19, 2003.

### BACKGROUND OF THE INVENTION

This invention relates to a process for imaging a lithographic printing plate and more particularly to a process using an ink jet printer to imagewise apply a near infrared absorbing imaging material to a plate coating, exposing the plate to a near infrared emitters, followed by developing the coating.

In the art of lithographic printing it is generally required that one or more lithographic printing plates be mounted on a printing press. The lithographic printing plate is characterized by having on its printing surface oleophilic ink receiving areas in the form of the image to be printed, and hydrophilic water receiving areas corresponding to the other, non-printing areas of the surface. Because of the immiscibility of oil-based lithographic inks and water, on a well-prepared printing plate, ink will fully coat the oleophilic areas of the plate printing surface and not contaminate the hydrophilic areas. The operating press brings the inked plate surface into intimate contact with an impression cylinder or elastic transfer blanket that transfers the ink image to the media to be printed.

Traditionally, a lithographic plate is photographically imaged. The plate substrate is most commonly aluminum, from 5 to 12 mils thick, treated so that the printing surface is hydrophilic, although treated or untreated plastic or paper substrates can also be used. The substrate is coated with a solution of a photosensitive composition that is generally oleophilic. Upon drying, the coating layer thickness is commonly about 1 to 3 microns thick. A printing plate with such a photosensitive coating is called “presensitized” (PS). Both negative and positive working photosensitive compositions are used in PS lithographic plates. In a negative plate, light exposure insolubilizes the coating, so that on development the only parts of the coating that aren't removed are the light imaged areas. The reverse is the case in a positive plate. Light exposure solubilizes the coating; on development the coating is only removed in the areas that are light imaged. In an image reversal process, a positive plate is “blanket exposed” or “flood exposed”, i.e., the entire plate is light exposed without any intervening mask or other means for imaging, and imaged in a separate step which can be performed before or after the blanket exposure step. By this image reversal process, a positive plate can be negatively imaged. The aluminum substrate can be treated to make it hydrophilic either prior to the application of the photosensitive composition or at the time the non-image areas of the coating are removed in a development step. Such a process in which a pre-coated lithographic plate is prepared for press by removing exclusively either the imaged or non-imaged coating in a development step is called a subtractive process; a pre-coated plate having a coating which is at least partially removed in a development step is known as a subtractive plate.

Photosensitive compositions used in positive lithographic plates are well known. They are comprised primarily of alkali soluble resins and o-quinone diazide sulfonic acid esters or amides. In addition dyes or colored pigments, indicator dyes, plasticizers and surfactants can also be present. The ingredients are typically dissolved in organic solvents and are coated onto the substrate. Upon drying a thin film or coating is produced.

Alkali soluble resins useful in positive plates are well known and include phenol-formaldehyde resins, cresol-formaldehyde resins, styrene-maleic anhydride copolymers, alkyl vinyl ether-maleic anhydride copolymers, co- or ter-polymers that contain either acrylic or methacrylic acids and poly(vinyl phenol). U.S. Pat. No. 4,642,282 describes an alkali soluble polycondensation product that is also useful as the resin component in positive plates.

The o-quinone diazide compounds include o-benzoquinone diazides, o-naphthoquinone diazides and o-anthraquinone diazides. O-quinone diazide compounds useful in positive plates are well known and are described in detail in Light Sensitive Systems by J. Kosar, p. 339-352. They are further described in U.S. Pat. Nos. 3,046,118; 3,046,119; 3,046,120; 3,046,121; 3,046,122; 3,046,123; 3,148,983; 3,181,461; 3,211,553; 3,635,709; 3,711,285 and 4,639,406 incorporated in entirety herein by reference.

Such positive plates are sensitive to light in the wavelength range of from about 290 to 500 nm. When used in the standard manner, photo-exposure causes the alkali insoluble o-quinone diazide of the positive plate to be converted into an alkali soluble carboxylic acid. Upon subsequent treatment with a developer, which is a dilute aqueous alkaline solution, the exposed parts of the coating are removed. The unexposed coating is alkali insoluble, because the o-quinone diazide is unaffected by the developer, and remains on the substrate.

Traditionally, lithographic plates are imaged by photographic transfer from original artwork. This process is labor-intensive and costly. Hence with the advent of the computer engendering a revolution in the graphics design process preparatory to printing, there have been extensive efforts to pattern printing plates, in particular lithographic printing plates, directly using a computer-controlled apparatus called a platesetter that is supplied with digital data corresponding to the image to be printed. A platesetter has the capability to supply an image forming agent, typically light energy or one or more chemicals, to a plate according to various patterns or images as defined by digital data, i.e., to imagewise apply an image forming agent. Specially manufactured lithographic plates may be required for certain types of platesetters. Such a combination of a computer-controlled platesetter and the proprietary plates used with them along with developer solutions and any other materials or apparatuses necessary to prepare the plates for printing is known as a computer-to-plate (CTP) system.

Heretofore, many of the new CTP systems have been large, complex, and expensive. They are designed for use by large printing companies as a means to streamline the prepress process of their printing operations and to take advantage of the rapid exchange and response to the digital information of graphic designs provided by their customers. Many of the new CTP systems use light sources, typically lasers, to directly image PS plates. But using lasers to image plates is very expensive, because the per-unit cost of the lasers is high and because they require sophisticated focusing optics and electronic controls. If because of the cost only a single laser is used, then time becomes a constraint because of the necessity of raster scanning. There remains a strong need for an economical and efficient CTP system for the many smaller printers who utilize lithographic printing.

In recent years, ink jet printers have replaced laser printers as the most popular hard copy output printers for computers. Ink jet printers have several competitive advantages over laser printers. One advantage is that it is possible to manufacture an array of 10's or even 100's of ink jet nozzles spaced very closely together in a single inexpensive print head. This nozzle array manufacturing capability enables fast printing ink jet devices to be manufactured at a much lower cost than laser printers requiring arrays of lasers. And the precision with which such a nozzle array can be manufactured and the jetting reliability of the incorporated nozzles means that these arrays can be used to print high quality images comparable to photo or laser imaging techniques. Ink jet printers also are increasingly being used for prepress proofing and other graphic arts applications requiring very high quality hard copy output. Ink jet printers are also scalable to larger sizes inexpensively allowing large format imaging at hitherto low prices.

In spite of the large and rapidly growing installed base of ink jet printers for hard copy output, ink jet printing technology is not commonly used in CTP systems. There are many challenging technical requirements facing the practitioner who would design such an ink jet based CTP system as can be seen in the prior art. A first requirement is that the ink jet ink used to image the printing plate be jettable, able to form ink drops of repeatable volume and in an unvarying direction. Further, for practical commercial application, the ink must have a long shelf life, in excess of one year or more. U.S. Pat. No. 5,970,873 (DeBoer et al) describes the jetting of a mixture of a sol precursor in a liquid to a suitably prepared printing substrate. But any ink constituents of limited solubility will render unlikely the practical formulation of a jettable, shelf-stable ink. Similar problems exist in U.S. Pat. No. 5,820,932 (Hallman et al) in which complex organic resins are jetted, and U.S. Pat. No. 5,738,013 (Kellet) in which marginally stable transition metal complexes are jetted. In U.S. Pat. No. 6,187,380 B1 (Hallman et al) and U.S. Pat. No. 6,131,514 (Simons), inks comprising acrylic resins such as trimethylolpropanetriacrylate and poly(ethylene-co-acrylic acid, sodium salt), are jetted. While it may be possible to make such a ink formulation work for the purposes of a short term experiment, it would almost certainly clog the nozzles of an ink jet printhead were the ink allowed to remain in the printer for the weeks or more that would be a requirement of practical commercial use.

Another requirement is that to be of wide utility, the ink jet based CTP system should be able to prepare printing plates with small printing dots, approximately 50 microns in diameter or smaller, so that high resolution images can be printed. Ink jet printers can produce such small dots, but of those having substantial commercial acceptance, only ink jet printers employing aqueous-based inks are practically capable of printing such small dots. Thus the systems described in U.S. Pat. No. 4,003,312 (Gunther), U.S. Pat. No. 5,495,803 (Gerber), U.S. Pat. No. 6,104,931 (Fromson et al), and U.S. Pat. No. 6,019,045 (Kato) which use solvent-based hot melt inks will not allow the preparation of the high resolution printing plates necessary for printed images of high quality. Further, hot melt type inks typically freeze on top of the imaged media rather than penetrate into it. This would prevent intimate mixing between potential reactants in the inks and corresponding potential reactants in a PS plate coating. It is also required that the prepared printing plates be rugged, capable of sustaining press runs of many thousands of impressions. The waxes used in the hot melt inks described in U.S. Pat. No. 6,019,045 (Kato) and U.S. Pat. No. 4,833,486 (Zerillo) would wear out in such a long press run.

Another requirement of a successful ink jet based CTP system is that a mature plate technology is to be preferred. Although the prior art demonstrates that it is not obvious to do so, it greatly simplifies the development of an ink jet CTP system to be able to use commercially available, widely accepted PS plates. There are many tradeoffs in the manufacture of commercially practical lithographic plates. They must be highly sensitive to the imaging process and yet thermally stable, stable in high humidity storage environments and yellow light, resistant to fingerprints, of minimal toxicity and environmentally benign, easily developed in that small dots are quantitatively resolved without dot blooming using developers that are of minimal toxicity and environmentally benign, able to sustain long press runs, manufacturable at a low cost per square foot, and many other practical requirements. U.S. Pat. No. 5,695,908 (Furukawa) describes a process for preparing a printing plate comprising a new plate coating containing a water-soluble polymer that becomes water-insoluble in contact with a metal ion in a solution jetted imagewise. But such a new plate coating is unlikely to meet the wide array of constraints on a successful plate technology. U.S. Pat. No. 5,466,653 (Ma et al) describes a plate coating that requires an impractically high reaction temperature for imaging. U.S. Pat. No. 6,025,022 (Matzinger) describes a new plate coating on a glass substrate that would be unlikely to find wide acceptance

To use an ink jet printer in a positive imaging process is impractical because in typical printing, the area of a plate containing images such as text, graphics, and line work, is much less that the non-image containing area of the plate. Thus to be able to image widely accepted positive plates with a negative imaging ink jet process is a unique, surprising, and valuable result.

Positive plates based on o-naphthoquinone diazide sulfonic acid esters can be modified by the incorporation of alkaline materials to obtain image reversal. U.S. Pat. No. 4,104,070 describes the use of imidazolines; U.S. Pat. No. 4,196,003 describes the addition of secondary and tertiary amines and U.S. Pat. No. 4,356,254 describes the addition of basic carbonium dyes to produce image reversal. The sequential steps for this image reversal process are imagewise light exposure, heat treatment, blanket light exposure and alkaline development. Those coatings have never achieved any commercial success, which is attributed to the adverse effect on the properties of the coating by the addition of the alkaline materials. U.S. Pat. No. 4,007,047 describes image reversal of a positive resist by a modification of the photoimaging process. After imagewise exposure, the resist coating is subjected to an acid treatment by immersion into a heated acid solution, which after a water rinse and drying steps produces a negative image after blanket light exposure and development.

The foregoing discussion of the prior art derives primarily from U.S. Pat. No. 6,691,618 in which a process for imaging a lithographic printing plate having a pre-sensitized coating is described in which droplets of an insoluablizing chemical in a solvent carrier are applied to a blanket exposed coating to produce an image.

On the other hand, methods also are know for making printing plates involving the use of imaging elements that are heat sensitive or switchable rather than photosensitive. See, for example, U.S. Pat. Nos. 6,699,640 and 6,605,407.

### SUMMARY OF THE INVENTION

The present invention provides a process for preparing lithographic plates for printing by employing an ink jet printhead to imagewise apply a near infrared absorbing material to a coated plate. The plate is then exposed to near infrared emitters which heats the coating only in areas where the fluid is applied and produce a solubility change in the underlying coating. Thereafter, upon subsequent treatment with a developer, an image forms that corresponds to the pattern where the near infrared absorbing material is ink jet printed onto the coating. In a negative working system, the coating is insolubilized where the near infrared absorbing material is applied, and on development those areas remain while the unimaged parts are dissolved. The resulting image plate can then be placed directly on a printing press to produce multiple copies.

### BRIEF DESCRIPTION OF THE DRAWINGS

Further features and advantages of the present invention will be seen from the following detailed description, taken in conjunction with the accompanying drawings, in which

FIG. 1 is a block diagram flow chart depicting a general process of the present invention; and

FIG. 2 is a block diagram flow chart depicting a process of the present invention used to image a presensitized printing plate in accordance with one embodiment of the present invention.

### DETAILED DESCRIPTION OF THE INVENTION

The invention comprises a process for preparing a printing plate for press by imagewise applying a near infrared absorbing imaging fluid to a coated plate, exposing the plate to near infrared emitters, and washing the plate with a developing solution. The near infrared absorbing imaging fluid absorbs energy causing a chemical change the underlying plate coating, making the changed coating insoluble to a developing solution in which the unchanged coating is soluble.

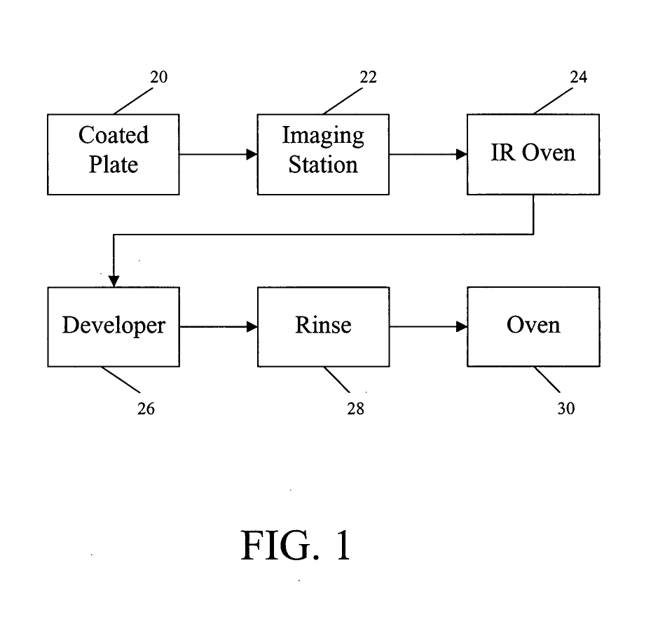

More particularly, the present invention enables thermally sensitive coatings to be imaged at a much lower cost than the current method of imaging using digitally controlled near infrared lasers. Referring to the attached FIG. 1, in this invention, the thermally sensitive coatings are imaged by much less costly ink jet printers that have the capability of producing high resolution images comparable to laser imaging. By ink jet printing, a fluid containing a near infrared absorbing material is applied imagewise to a coated plate, followed by placing the coated plate in an oven having near infrared emitters. The coating is heated only in the areas where the fluid is applied which produces a solubility change in the coating. On subsequent treatment with a developer, an image will form that corresponds to the pattern that is ink jet printed onto the coating. In a negative working system, the coating is insolubilized where the fluid is applied and on development those areas remain while the unimaged parts are dissolved. The imaged plate can then be placed on a printing press to produce multiple copies. Alternatively, the imaging fluid may be used in a positive working system.

A computer-to-plate system according to the invention preferably comprises an ink jet printer (IJP), an oven having near infrared emitters, and a developing processor. To facilitate accurate imaging of the plate, the paper-handling or substrate-handling subsystem of ink jet printer should have a short, straight paper path. A printing plate is generally stiffer and heavier than the paper or media typically used in commercially available ink jet printers. If the plate fed into the printer mechanism must bend before or after being presented to the imaging print head, then the movement of the plate through the printer may not be as accurate as the media for which the printer was designed. One preferred printer is the EPSON Stylus Color 7600 available from Epson America, Inc., Long Beach, Calif., has such a short, straight paper path. A platen is preferably placed at the entrance to the paper feed mechanism. The platen preferably has a registration guide rail and supports the plate as it is pulled into the printer by the feed mechanism, facilitating the accurate transport of the plate under the imaging print head.

In a preferred embodiment, the IJP used is a commercially available drop-on-demand printer capable of printing small ink drops having volumes no larger than 4 picoliters (4 pl) such as the EPSON Stylus Color 7600 ink jet printer available. However, the great flexibility available to the practitioner in formulating near infrared absorbing imaging materials according to the invention means that a well-performing jettable imaging solution can be formulated such that the print head of almost any ink jet printer will be able to form regular drops with good reliability.

The oven required for use in the imaging process in accordance with the present invention may be simple and inexpensive. The oven may be a batch or flow through oven having near infrared emitters such as laser diodes. The emission wavelength of the infrared emitters should be matched to the absorption bandwidth of the near infrared absorbing material contained in the imaging ink. By way of example, compounds having OH and NH groups typically absorb at 2.2-3.2 microns. Most aromatics and olefins absorb at about 3.2-3.3 microns. Aliphatics typically absorb at about 3.33-3.55 microns, while aldehydes, ketones, some organic acids and amides typically absorb in the range of 5.7-6.1 microns. Various laser diodes are available commercially that emit radiation in the above ranges.

The coating should be a material whose solubility is changed upon heating. Many coatings are useful in this near infrared imaging process. Preferred coatings include
1. photo-crosslinkable polymeric and polyazide binders;
2. resole and novolac resins with a latent bronsted acid;
3. heat setting monomers and binder resins;
4. monomers with a heat activated polymerization initiator;
5. novolac resins with a naphthoquinone diazide sulfonic acid ester;
6. diazo resins; and,
7. ablative materials.

Preferred infrared absorbing imaging materials useful in the imaging fluids in accordance with the present invention include squarylium dyes such as squarylium dye III, croconate dyes such as croconate blue, phthalocynanine, merocyanine dyes such as merocyanine 540, indolizine, pyrlium, dithiolene, metal complexes, carbon black, phthalocyanine and infrared absorption dyes such as ADS 830 AT (available commercially from American Dye Source, Inc.).

For reliable jetting, and so that during idle periods the imaging fluid does not dry out in the ink jet nozzle causing it to clog, a humidifying co-solvent may be added to the insolubilizing fluid. The co-solvent can be a polyhydric alcohol such as glycerin, ethoxylated glycerin, ethylene glycol, diethylene glycol, triethylene glycol, propylene glycol, dipropylene glycol, or trimethylol propane, other high boiling point liquids such as pyrrolidone, methylpyrrolidone, or triethanol amine, other simple alcohols such as isopropyl alcohol or tertiary butyl alcohol, or mixtures of such solvents. When used, the co-solvent would typically comprise 5 to 70 percent of the imaging fluid.

While generally not necessary, a dye compatible with the near infrared absorbing imaging fluid may be added to the imaging fluid at a level of a few percent to further enhance the visibility of the latent image. The near infrared absorbing imaging fluid may also contain one or more surfactants or wetting agents to control the surface tension of the ink, enhance jettability, and control spread and penetration of the drop on the coated plate. Suitable surfactants and wetting agents include Surfynol 104, Surfynol 465, Surfynol FS-80, Surfynol PSA-216, Dynol 604, Triton X-100, and similar chemicals or mixtures of similar chemicals. When used, surfactants and wetting agents typically comprise 0.001 to 10 weight percent of the imaging fluid.

The near infrared absorbing imaging fluid also may contain one or more biocides to prolong the shelf life of the fluid. Suitable biocides include for example Proxel GXL, Sodium Omadine, Dowicil, GivGuard DXN, and similar chemicals or mixtures of such chemicals. When used, the biocide would typically comprise 0.1 to 3 weight percent of the imaging fluid. If the pH of the imaging fluid is over 10, it is not necessary to use a biocide and this is preferred.

A typical formulation for near infrared absorbing imaging fluid in accordance with the present invention comprises:

| | |
|---|---|
| Near infrared absorbing imaging material | 98% |
| in a suitable solvent | |
| Surfactant and biocide | 2% |

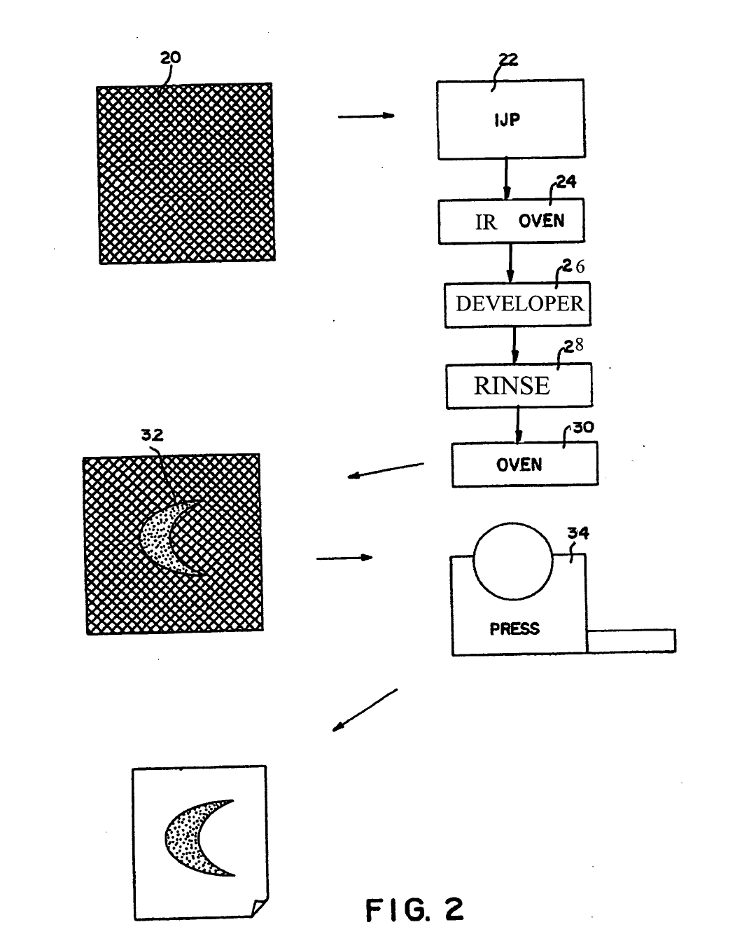

Imagewise application of the near infrared absorbing imaging fluid onto the plate coating using an ink jet printhead results in a latent image on the plate. To complete preparation for use, it is then necessary to expose the imaged plate to near infrared emitters, and then to use a conventional developing processor. A preferred process configuration is illustrated in FIGS. 1, 2 and 4. A coated plate 20 is conveyed first through an imaging station 22 where a near infrared imaging fluid is imagewise applied. The plate is then conveyed through a oven 24 having near infrared emitters. The coating is heated only in areas where the imaging fluid is applied, which produces a solubility change in the coating. Then, the plated is conveyed through a development station 26 where an appropriate developing solution is applied to the plate and the solubilized coating removed. The plate is then conveyed through a rinse section 28, and finally, fifth through a drying oven 30. The resulting plate is then ready to be used on a press 34.

Alternatively, a positive plate may be prepared by a image reversal process in which the plate is coated with a subtractive coating. A near infrared absorbing imaging fluid is applied imagewise to the coating using an ink jet printer as before. The imaged plate is then conveyed through a oven having infrared emitters, and then through a development, rinse and drying station. The plate is then ready for use.

The invention will be further described in connection with the following non-limiting examples.

### EXAMPLE 1

A infrared absorbing imaging fluid is prepared by dissolving squarylium dye III in to form a near infrared sensitive imaging solution comprising 6 weight % of the fluid. A surfactant (Triton X-100 and a biocide, Proxel GXL) where added in weight amounts of 0.2% and 0.3% percent, respectively.

The imaging solution is image jetted onto an aluminum plate precoated with a Novolac resin and a naphthoquione diozide sulfonic acid ester. The image plate is then exposed to an oven having infrared emitters followed by development in an alkaline developer solution of the following composition:

| | |
|---|---|
| Sodium metasilicatepentahydrate | 55 grams |
| (from the PQ Corp. under the name Pentabead 50) | |
| Aerosol OS Surfactant from Cytec | 2.2 grams |
| Water | 1000 ml |

The parts of the coating underlying the imaging solution are insoluablized by heat absorbed by the imaging material. The other parts of the coating are soluble in the developer and are removed. The plate is then washed to remove the developer and any imaging material that was not removed by the developing solution, leaving images on the coated plate that correspond to the images of the early applied near infrared absorbing solution. The plate is then dried.

The foregoing is exemplary and not intended to limit the scope of the claims that follow.

1. A method of imaging a lithographic printing plate having a heat sensitive coating, comprising the steps of:
(a) imagewise applying droplets of a near infrared absorbing imaging material to the plate coating;
(b) exposing the plate to near infrared emitters; and
(c) developing the coating.

2. The process of claim 1 further comprising the step of:
(d) washing the developed plate.

3. The method of claim 2 further comprising the step of:
(e) drying the washed plate.

4. The method of claim 1 wherein the near infrared absorbing imaging material absorbs in the 2.2-3.2 micron range.

5. The method of claim 1 wherein the near infrared absorbing imaging material absorbs in the 3.2-3.3 micron range.

6. The method of claim 1 wherein the near infrared absorbing imaging material absorbs in the 3.33-3.55 micron range.

7. The method of claim 1 wherein the near infrared absorbing imaging material absorbs in the 5.7-6.1 micron range.

8. The process of claim 1 wherein said coating comprises a photo-crosslinkable polymeric and polyazide binder.

9. The process of claim 1 wherein said coating comprises a resole and novolac resin with a latent bronsted acid.

10. The process of claim 1 wherein said coating comprises a heat setting monomer and binder resins.

11. The process of claim 1 wherein said coating comprises a monomer with a heat activated polymerization initiator.

12. The process of claim 1 wherein said coating comprises a novolac resin with a naphthoquinone diazide sulfonic acid ester.

13. The process of claim 1 wherein said coating comprises a diazo resin.

14. The process of claim 1 wherein said coating comprises ablative materials.

15. The method of claim 1 wherein the near infrared absorbing imaging material comprises a dye.

16. The method of claim 15 wherein the dye is selected from the group consisting of a squarylium dye, croconate dye, phthalocynanine, a merocyanine dye, indolizine, pyrlium, dithiolene, a metal complex, carbon black, and phthalocyanine.
